(19) United States
(12) Patent Application Publication
(10) Pub. No.: US 2026/0276599 A1
(43) Pub. Date: Sep. 17, 2026

(54) ELECTROMAGNETIC ACOUSTIC TRANSDUCER (EMAT) FOR INSPECTION

(71) Applicant: Evident Canada, Inc., Québec (CA)

(72) Inventor: Cong Zhu Sun, Lac-Sergent (CA)

(21) Appl. No.: 19/470,420

(22) PCT Filed: Mar. 27, 2024
(86) PCT No.: PCT/CA2024/050376

§ 371 Date: Sep. 29, 2025

Related U.S. Application Data
(60) Provisional application No. 63/493,224, filed on Mar. 30, 2023.

(51) Int. Cl. G01N 29/24; G01N 29/06; G01N 29/26

(52) U.S. Cl. CPC G01N 29/2412; G01N 29/0645; G01N 29/262; G01N 2291/0258; G01N 2291/106

(57) ABSTRACT

An electromagnetic acoustic transducer (EMAT) can be used in a variety of applications, such as those involving higher temperatures. No couplant or wedge is required, and such transducers are less affected by surface coatings and condition of objects under test. Such transducers can be configured to operate continuously at extreme temperatures, and such transducers can be made more robust because an active surface in contact with a test specimen does not have to transmit acoustic waves. For example, because acoustic excitation occurs in the test specimen, the wear plate can be made of very hard materials such as a ceramic material. Shielding between transducer coil elements can facilitate reduction to lift-off induced variation in resolution or such shielding can facilitate finer coil-to-coil pitch, as illustrative examples.

### CLAIM OF PRIORITY

This patent application claims the benefit of priority of Cong Zhu Sun, U.S. Provisional Patent Application No. 63/493,224, titled “ELECTROMAGNETIC ACOUSTIC TRANSDUCER (EMAT) FOR INSPECTION,” filed on Mar. 30, 2023 (Attorney Docket No. 6409.254PRV), which is hereby incorporated by reference herein in its entirety.

### FIELD OF THE DISCLOSURE

This document pertains generally, but not by way of limitation, to non-destructive evaluation, and more particularly, to apparatus and techniques for an electromagnetic acoustic transducer that is operable over an extended temperature range as compared to generally available piezo electric transducers.

### BACKGROUND

Non-destructive testing (NDT) can refer to use of one or more different techniques to inspect regions on or within an object, such as to ascertain whether flaws or defects exist, or to otherwise characterize the object being inspected. Examples of non-destructive test approaches can include use of an eddy-current testing approach where electromagnetic energy is applied to the object and resulting induced currents on or within the object are detected, with the values of a detected current (or a related impedance) providing an indication of the structure of the object under test, such as to indicate a presence of a crack, void, porosity, or other inhomogeneity.

Another approach for NDT can include use of an acoustic inspection technique, such as where one or more electroacoustic transducers are used to insonify a region on or within the object under test, and acoustic energy that is scattered or reflected can be detected and processed. Such scattered or reflected energy can be referred to as an acoustic echo signal. Generally, such an acoustic inspection scheme involves use of acoustic frequencies in an ultrasonic range of frequencies, such as including pulses having energy in a specified range that can include value from, for example, a few hundred kilohertz, to tens of megahertz, as an illustrative example.

### SUMMARY OF THE DISCLOSURE

Acoustic testing, such as ultrasound-based inspection, can include use of individual transducers, or arrays of such transducers including providing focusing or beam-forming techniques to aid in construction of data plots or images representing a region of interest on or within a test specimen. Use of an array of ultrasound transducer elements can include use of a phased-array beamforming approach and can be referred to as Phased Array Ultrasound Testing (PAUT). For example, a delay-and-sum beamforming technique can be used such as including coherently summing time-domain representations of received acoustic signals from respective transducer elements or apertures. In another approach, a Total Focusing Method (TFM) beamforming technique can be used where one or more elements in an array (or apertures defined by such elements) are used to transmit an acoustic pulse and other elements are used to receive scattered or reflected acoustic energy, and a matrix is constructed of time-series (e.g., A-Scan) representations corresponding to a sequence of transmit-receive cycles in which the transmissions are occurring from different elements (or corresponding apertures) in the array.

Such a TFM approach where A-scan data is obtained for each element in an array (or each defined aperture) can be referred to as a “full matrix capture” (FMC) technique. In a manner similar to TFM imaging, a phase-based approach can be used for one or more of acquisition, storage, or subsequent analysis. Such a phase-based approach can include coherent summation of normalized or quantized representations of A-Scan data corresponding to phase information. Such an approach can be referred to as a “phase coherence imaging” (PCI) beamforming technique.

One challenge presented by use of generally available piezoelectric transducers is corrosion mapping (or other testing) at temperatures other than ambient, such as at elevated (e.g., hundreds of degrees Celsius, or depressed temperatures, such as freezing or below-freezing. While piezoelectric probes are serviceable at lower temperatures (<60° C.), such as around ambient temperatures, their performance and longevity sharply degrade when the temperature is higher, such as the case for many industrial processes. Such sensor may also be unsuitable for extremely cold environments.

Probes used in applications involving elevated temperature may be equipped with cooling or otherwise used with specified down time in order to prevent overheating. Coupling wedges for use with acoustic probes can experience large temperature gradients, which can distort the signal. High temperature plastics may generally attenuate higher frequencies, reducing resolution. Specialized high temperature couplant is expensive and difficult to work with. The present inventor has recognized that virtually every part of a generally available piezoelectric transducer setup becomes much more complicated and expensive for operation at temperature extremes and may even fail to support the high resolution that is expected from such equipment in lower-temperature applications.

The present inventor has, among other things, recognized that an electromagnetic acoustic transducer (EMAT) can be used in a variety of applications, such as those involving higher temperatures. No couplant or wedge is required, and such transducers are less affected by surface coatings and condition of objects under test. Such transducers can be configured to operate continuously at high temperatures, and such transducers can be made more robust because an active surface in contact with a test specimen does not have to transmit acoustic waves. For example, because acoustic excitation occurs in the test specimen, the present inventor has recognized among other things that a wear plate can be made of very hard materials such as a ceramic material. The present inventor has also recognized, among other things, that shielding between transducer coil elements can facilitate reduced lift-off induced variation in resolution or such shielding can facilitate finer coil-to-coil pitch, as illustrative examples.

In an example, an electromagnetic acoustic transducer (EMAT) assembly for non-destructive test (NDT) can include a static magnetic field generator, a first transducer coil, a second transducer coil, and a conductive shield located laterally between the first transducer coil and the second transducer coil, the conductive shield extending away from the first transducer coil and the second transducer coil toward a surface of the EMAT assembly, the surface configured to face an object under test. The EMAT assembly can include a non-conductive plate defining the surface. In an example, the conductive shield can extend at least partially through the non-conductive plate, or even through an entirety of the non-conductive plate.

In an example, a method can include operating the EMAT assembly for non-destructive test. For example, the method can include placing the surface of the EMAT on or near an object under test, selectively energizing at least one of the first transducer coil or the second transducer coil to electromagnetically induce an acoustic pulse in the object under test in a presence of a static magnetic field, and electromagnetically detecting a scattered or reflected acoustic energy from the object under test elicited in response to the acoustic pulse.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example comprising an acoustic inspection system, such as can be used to perform at least a portion one or more techniques as shown and described herein.

FIG. 2A and FIG. 2B illustrate front and side section views of an electromagnetic acoustic transducer (EMAT) assembly including a conductive shield.

FIG. 2C is an illustrative example of dimensional definitions that can be used in establishing the EMAT assembly configuration.

FIG. 2D shows an illustration of generalized principles of operation of an EMAT assembly, where a conductive shield provides reduction or suppression of crosstalk between adjacent transducer coils.

FIG. 3A and FIG. 3B illustrate views of EMAT assemblies having different overall coil assembly thicknesses.

FIG. 4A and FIG. 4B illustrate views of EMAT assemblies using a coil configuration that differs from other examples in this document, showing that at a scale (e.g., coil-to-coil pitch) generally used for phased-array applications, spatial confinement and resolution are lost when the configuration of FIG. 4A or FIG. 4B is used.

FIG. 5A and FIG. 5B illustrate views of an EMAT assembly similar to FIG. 4A, showing a sensitivity to lift-off, by contrast with other examples in this document.

FIG. 6A and FIG. 6B illustrate views of illustrative examples of EMAT assemblies similar to the configuration of FIG. 2A and FIG. 2B, illustrating generally that spatial confinement can be maintained for a variety of different lateral widths of coil configuration, and FIG. 6C showing consistency in induced current and associated magnetic field configuration versus lift-off.

FIG. 7A and FIG. 7B show illustrative examples of an envelope of an A-scan in FIG. 7A, and an A-scan time series in FIG. 7B, both obtained using a single EMAT transducer having a configuration similar to that shown in FIG. 2A and FIG. 2B.

FIG. 7C shows an illustrative example of crosstalk (in dB) between adjacent transducers in a 5-element EMAT phased array having a configuration similar to that shown in FIG. 2A and FIG. 2B, versus a piezoelectric phased array transducer assembly.

FIG. 8 illustrates generally a technique, such as a method, for operating an EMAT such as for generating an acoustic pulse within an object under test, or for detecting echoes elicited by such a pulse (or both).

### DETAILED DESCRIPTION

Apparatus and techniques described herein can include or can use an electromagnetic acoustic transducer (EMAT), such as for performing acoustic inspection in a non-destructive manner. Use of an EMAT assembly instead of a piezoelectric transducer allows inspection of structures at temperatures elevated above ambient temperature. An EMAT probe configuration does not require use of a liquid couplant. Aspects of the present subject matter can include use of an EMAT probe configuration for various acoustic inspection applications such as thickness measurement, corrosion mapping, or phased-array applications such as imaging using PAUT or TFM beamforming techniques.

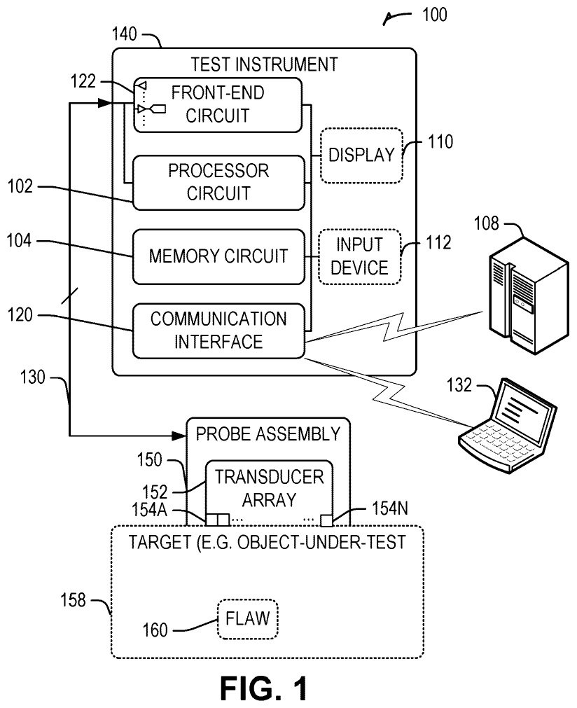

FIG. 1 illustrates generally an example comprising an acoustic inspection system 100, such as can be used to perform at least a portion one or more techniques as shown and described herein. The inspection system 100 can include a test instrument 140, such as a hand-held or portable assembly. The test instrument 140 can be electrically coupled to a probe assembly 150, such as using a multi-conductor interconnect 130. The probe assembly 150 can include one or more electromagnetic acoustic transducers (EMATs), such as defining a transducer array 152 including respective transducers 154A through 154N. The transducers array can follow a linear or curved contour or can include an array of elements, or a matrix configuration, as illustrative examples.

A modular probe assembly 150 configuration can be used, such as to allow a test instrument 140 to be used with various different probe assemblies. Generally, the transducer array 152 includes EMATS that are electromagnetically coupled with a target 158 (e.g., a test specimen or “object-under-test”) without requiring use of a wedge or liquid coupling medium. As mentioned elsewhere herein, use of EMAT allows testing of structures at temperatures elevated above ambient temperature or at depressed temperature. Examples of such structures include vessels, pipelines, or other structures having temperatures of tens or hundreds of degrees Celsius above ambient indoor temperature, or temperatures below ambient indoor temperature, such as below freezing.

The test instrument 140 can include digital and analog circuitry, such as a front-end circuit 122 including one or more transmit signal chains, receive signal chains, or switching circuitry (e.g., transmit/receive switching circuitry). The transmit signal chain can include amplifier and filter circuitry, such as to provide transmit pulses for delivery through an interconnect 130 to a probe assembly 150 such as to image or otherwise detect a flaw 160 on or within the target 158 structure by receiving scattered or reflected acoustic energy elicited in response to the insonification.

While FIG. 1 shows a single probe assembly 150 and a single transducer array 152, other configurations can be used, such as multiple probe assemblies connected to a single test instrument 140, or multiple transducer arrays 152 used with a single probe assembly 150 or multiple probe assemblies for pitch/catch inspection modes. Similarly, a test protocol can be performed using coordination between multiple test instruments 140, such as in response to an overall test scheme established from a master test instrument 140 or established by another remote system such as a compute facility 108 or general-purpose computing device such as a laptop 132, tablet, smart-phone, desktop computer, or the like. The test scheme may be established according to a published standard or regulatory requirement and may be performed upon initial fabrication or on a recurring basis for ongoing surveillance, as illustrative examples.

The receive signal chain of the front-end circuit 122 can include one or more filters or amplifier circuits, along with an analog-to-digital conversion facility, such as to digitize echo signals received using the probe assembly 150. Digitization can be performed coherently, such as to provide multiple channels of digitized data aligned or referenced to each other in time or phase. The front-end circuit can be coupled to and controlled by one or more processor circuits, such as a processor circuit 102 included as a portion of the test instrument 140. The processor circuit can be coupled to a memory circuit 104, such as to execute instructions that cause the test instrument 140 to perform one or more of acoustic transmission, acoustic acquisition, processing, or storage of data relating to an acoustic inspection, or to otherwise perform techniques as shown and described herein. The test instrument 140 can be communicatively coupled to other portions of the system 100, such as using a wired or wireless communication interface 120.

For example, performance of one or more techniques as shown and described herein can be accomplished on-board the test instrument 140 or using other processing or storage facilities such as using a compute facility 108 or a general-purpose computing device such as a laptop 132, tablet, smart-phone, desktop computer, or the like. For example, processing tasks that would be undesirably slow if performed on-board the test instrument 140 or beyond the capabilities of the test instrument 140 can be performed remotely (e.g., on a separate system), such as in response to a request from the test instrument 140. Similarly, storage of imaging data or intermediate data such as A-scan matrices of time-series data or other representations of such data, for example, can be accomplished using remote facilities communicatively coupled to the test instrument 140. The test instrument can include a display 110, such as for presentation of configuration Information or results, and an input device 112 such as including one or more of a keyboard, trackball, function keys or soft keys, mouse-interface, touch-screen, stylus, or the like, for receiving operator commands, configuration information, or responses to queries.

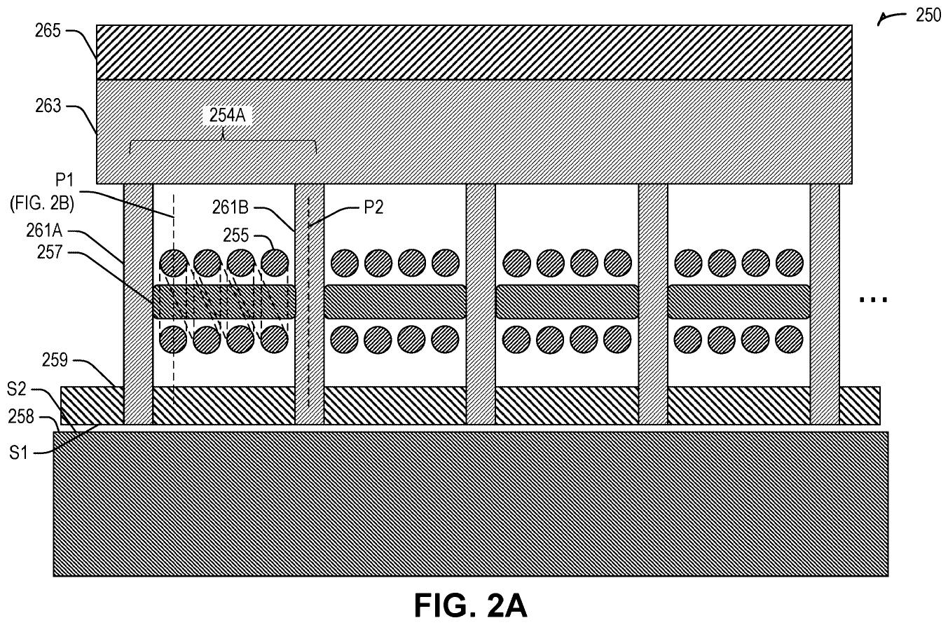

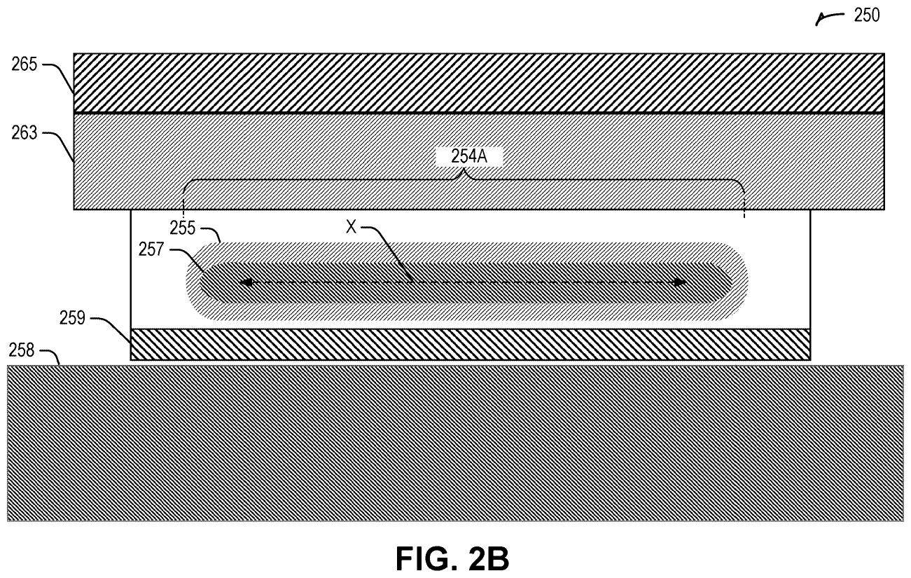

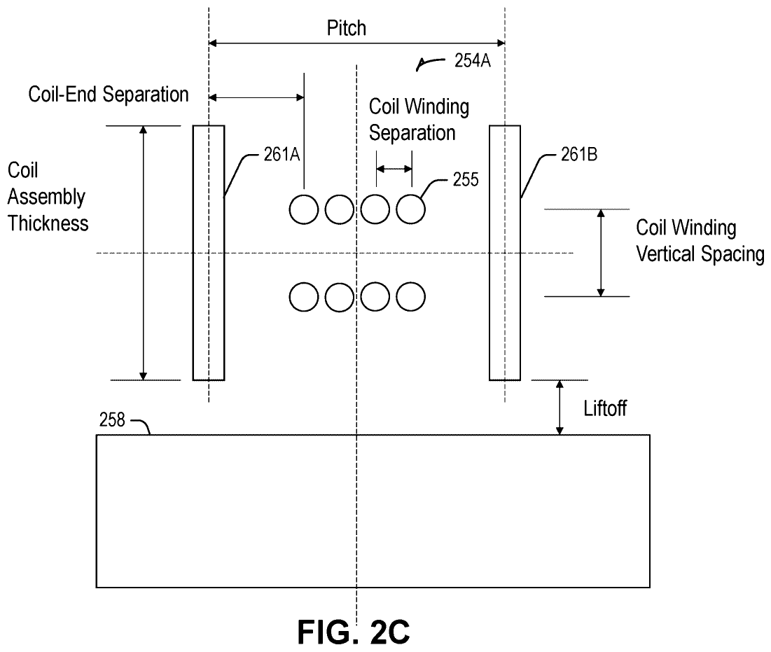

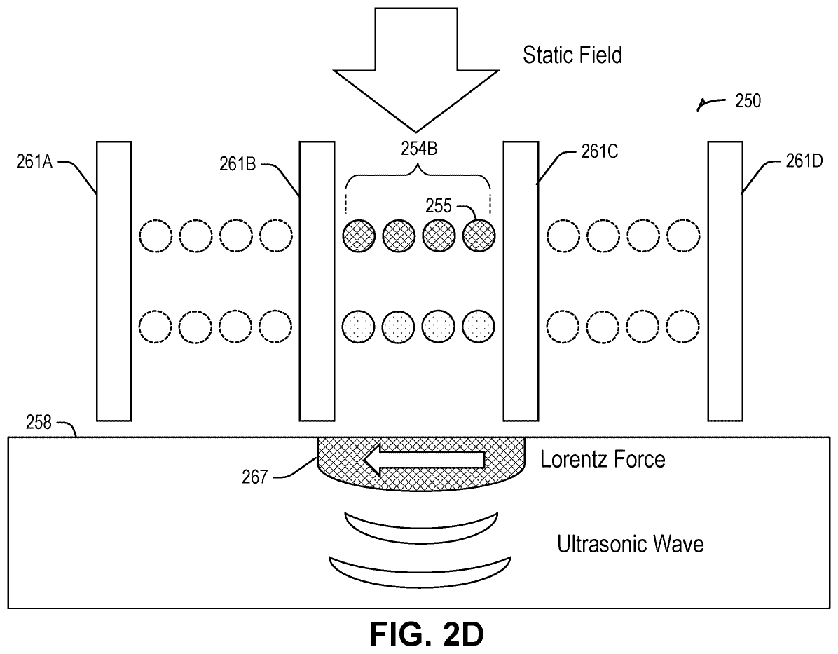

FIG. 2A and FIG. 2B illustrate front and side section views of an electromagnetic acoustic transducer (EMAT) assembly 250 including a conductive shield. As shown and described in this document, the EMAT assembly 250 can include at least one transducer coil 254A defined by a winding 255, such as having a specified count of turns generally oriented in a plane P1 that is orthogonal to a surface S1 of the EMAT assembly 250 that is placed on or nearby a surface S2 of an object under test (e.g., a conductive target 258). The transducer coil 254A can be wound about a bobbin or other structure, such as an insulator 257. The transducer coil 254A can be lacquered or potted, such as to stabilize and immobilize the transducer coil 254A winding 255. As shown in FIG. 2B, specifically, the winding 255 can be non-circular in profile, such as elongated in one direction, indicated by the axis X in FIG. 2B, such as in a direction parallel to the surface S2 of the conductive target 258.

The present inventor has recognized that use of a conductive shield, such as defining one or more walls 261A and 261B (as shown in FIG. 2A and similarly in other examples herein), can help to isolate the transducer coil 254A from adjacent transducer coils, or to help maintain uniformity of an induced current and associated magnetic field within the conductive target 258 (or both), as shown and described in examples elsewhere herein. Generally, as discussed below, the configuration of an induced current distribution within the conductive target 258 will coincide with an area where Lorentz force effects will result in generation of an acoustic shear wave. The conductive shield can define a wall 261B between the transducer coil 254A and an adjacent coil. The one or more walls 261A and 261B can be oriented (e.g., as shown by a plane P2) substantially parallel to a plane P1 of the winding 255 (such as defining a plane of the section view of FIG. 2B). The conductive shield can include a conductive cap 263 conductively coupled to conductive walls (e.g., conductive wall 261A and 261B) and located opposite a portion of the walls extending away from the transducer coils toward the surface S1 facing the target 258. Similar to the walls (e.g., conductive wall 261A and 261B), the conductive cap can help to constrain flux generated by the transducer coil 254A to avoid coupling with adjacent transducer coils or otherwise leaking from the EMAT assembly 250, by eddy current effects where a complementary current distribution is induced near the surface of the cap 263 that attempts to buck the changing magnetic field generated by the winding 255.

The EMAT assembly 250 can include a non-conductive plate 259, such as serving as a wear plate, and through which the conductive walls (e.g., walls 261A and 261B) extend either partially or through an entirety of the non-conductive plate 259 (as shown in FIG. 2A). The wear plate can include a ceramic or polymer material. Use of a ceramic material can provide durability and immunity to high temperature, and such a material need not serve as an acoustic matching layer, because transmission or detection of acoustic signals associated with the conductive target 258 occurs through electromagnetic coupling rather than acoustic coupling between the EMAT assembly 250 and the conductive target 258. Generally, the non-conductive plate 259 and any exposed portions of the walls 261A and 261B are configured to wear together over time from contact of the surface with the object under test. Extension of the walls 261A and 261B toward the target 258 through the wear plate can help to provide a consistent induced current distribution in the target 258 that is less susceptible to variation due to lift-off effects and also helps to reduce or suppress cross-talk, as discussed below. The non-conductive plate 259 and any exposed portions of the walls 261A and 261B can be configured for continuous exposure without degradation to an object under test at above-ambient or below-ambient temperatures with suitable materials. A wider selection of materials are available for continuous extreme temperature operation because in the EMAT configuration, there is no requirement for acoustic transmission from the probe assembly to the object under test or vice versa.

As discussed below, a static magnetic field can be generated using a magnet 265 (comprising either a permanent magnet or an electromagnet, or combinations thereof).

Alternatively, or in addition to the examples above, a lift-off ring or spacer can be located at surface S1, such as to maintain the EMAT assembly 250 at a specified distance from the conductive target 258. The EMAT assembly 250 can be equipped with rollers or supported by a carriage, such as to facilitate repositioning or mechanical scanning. If a permanent magnet is used for the magnet 265, a lever or other mechanical actuator can be used to raise and lower the EMAT assembly 250 to disengage the EMAT assembly 250 for re-positioning (where such an assembly 250 might otherwise be “stuck” to the target 258 due to the static magnetic field produced by magnet 265 if a permanent magnet is used). In FIG. 2A and FIG. 2B, four transducer elements (e.g., “channel” blocks or units) are shown, but such an example is merely illustrative, and a count of channels can be varied, such as by adding similar blocks laterally.

FIG. 2C is an illustrative example of dimensional definitions that can be used in establishing the EMAT assembly configuration, such as with respect to a unit element defined by a transducer coil 254A. An overall coil assembly thickness (and corresponding wall 261A and wall 261B height) is generally specified to be greater than a coil vertical winding spacing, such as to help avoid unwanted flux linkage between adjacent transducer coils in an array. Similarly, a coil-end separation can be defined in part to avoid mutual coupling between adjacent transducer coils, with greater separation resulting in less crosstalk. A trade-off may generally exist where such separation is desired to be minimized to provide a compact array configuration having a specified coil-to-coil pitch (e.g., 1 millimeter) for phased-array applications. The present inventor has recognized among other things that a single-layer coil may also provide reduced crosstalk, but that additional winding 255 layers can increase signal strength by increasing flux. Such an increase in signal strength may come at the cost of worse signal-to-noise ratio due to crosstalk effects. Coil winding separation (with a single-layer coil shown in FIG. 2C) can be established in part based on engineering considerations such as winding conductor diameter, insulation thickness, or other considerations such as winding uniformity if wound mechanically about a bobbin or other core structure.

As discussed above, a conductive shield comprising one or more walls such as walls 261A and 261B can isolate transducer coils from each other in an array of EMATs. A thickness of the shield conductor can be specified to be about two times (or more) greater than a skin depth corresponding to a specified target frequency, such as a center frequency of operation. Generally, a material used for the conductive shield is specified to be non-magnetic (e.g., a non-ferrous material having a relative magnetic permeability at or near unity). Use of non-magnetic material avoids increasing a self inductance of the winding 255 and use of a magnetic material may result in static magnetic field distortion, which adversely affects the ultrasonic beam produced by the EMAT.

Use of the conductive shield defining walls 261A and 261B, and a cap (if present) may result in some attenuation of signal strength (e.g., on the order of a few dB), but with crosstalk reduction (e.g., improvement) of tens of dB. Use of the conductive shield defining walls 261A and 261B can also (or instead) provide greater reduction to lift-off induced variation in the spatial extent of acoustic excitation, providing more consistent resolution at different lift-off heights by concentrating flux within the footprint of the region between the walls 261A and 261B as discussed below.

FIG. 2D shows an illustration of generalized principles of operation of an EMAT assembly 250, where a conductive shield defining walls (e.g., walls 261A, 261B, 261C, and 261D) provides reduction or suppression of crosstalk between adjacent transducer coils. Generally, in the examples described in FIG. 2A, FIG. 2B, FIG. 2C, and FIG. 2D, a top half of the winding 255 carries current in a first direction, and the bottom half of the winding 255 carries current in the opposite direction, with the winding 255 forming turns about an insulator. A permanent magnet or an electromagnetic can generate a static magnetic field. When the winding 255 of transducer coil 254B is energized by a time-varying magnetic field, Lorentz forces are generated. The induced magnetic field 267 in the object under test (e.g., conductive target 258) and associated Lorentz force result in generation of acoustic shear waves within the conductive target 258 itself. A reciprocal physical effect can be used to detect acoustic echo signals (e.g., scattered or reflected acoustic energy) from within the target 258, where the acoustic echo signals are elicited in response to an induced acoustic pulse, such as corresponding to a flaw or other feature on or within the conductive target 258.

Piezoelectric transducers do not generally exhibit significant crosstalk between elements. By contrast, an array of EMATs may be vulnerable to crosstalk due to mutual inductive coupling of magnetic flux between transducer coils. Driving a time-varying current through one transducer coil generally induces current through adjacent channels and may reduce spatial resolution in both transmission and reception. Increasing excitation power may decrease the effect of random electronic noise but proportionately increases the amplitude of the crosstalk, which blurs the true received echo of one particular channel with that of its neighbors. Similarly, decreasing coil pitch may enhance spatial resolution up to a certain threshold, but upon greater reduction in pitch, clarity of any resulting imaging may not further improve due to crosstalk effects. For example, a 1-millimeter (mm) pitch phased-array (PA) EMAT assembly may perform as if it had 3-mm pitch (or greater) due to crosstalk effects but retain the lower signal-to-noise ratio of a 1-mm pitch, in the absence of the shielding techniques and winding configurations discussed herein.

EMAT configurations such as shown illustratively in FIG. 2A and FIG. 2B can help reduce or suppress crosstalk between channels, though signal strength may be sacrificed in the process, as mentioned above. By using copper or another non-ferromagnetic conductor for conductive shielding structures in this configuration, a trade-off can exist between an increase in self-inductance of a respective coil and crosstalk between channels. Eddy currents induced by a transducer coil in the shield create counter currents (and counter magnetic fields as a result) constraining the magnetic field produced by each coil channel.

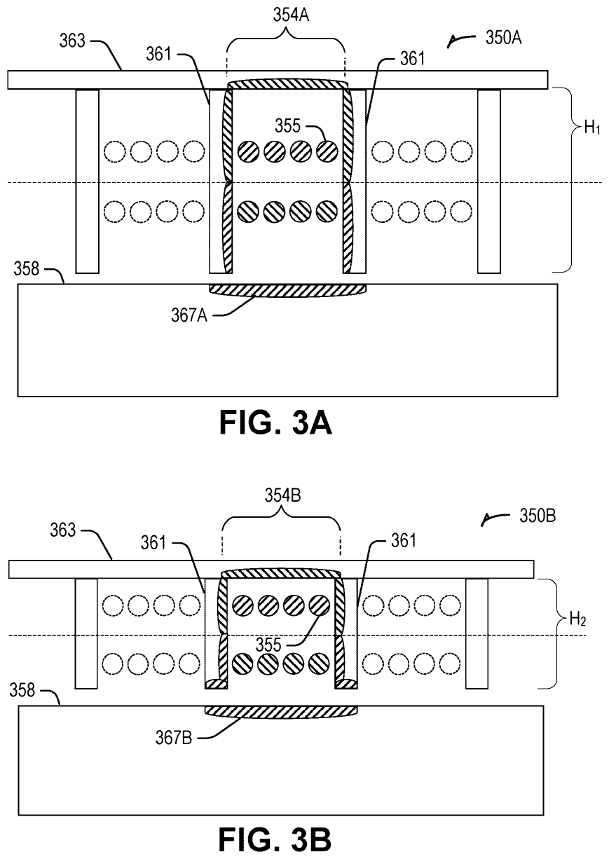

FIG. 3A and FIG. 3B illustrate views of EMAT assemblies 350A (in FIG. 3A) and 350B (in FIG. 3B) having different overall coil assembly thicknesses. In FIG. 3A and FIG. 3B, hatching indicates a current direction (either into or out of a plane of the page), and complementary induced magnetic field distributions associated with image currents within adjacent conductive shield walls 361 and conductive shield cap 363. As shown in FIG. 3A, such induced magnetic field distributions are largely confined to surfaces of the walls 361 and cap 363 facing the winding 355 of the transducer coil 354A. A footprint of a corresponding induced field 367A within the target 358 roughly corresponds to the opening between the walls 361. If the overall coil thickness is reduced as shown in the in the EMAT assembly 350B of FIG. 3B, comprising transducer coil 354B, the induced field distributions begin to wrap around the conductive shield walls 361 but the associated induced field 367B is still roughly within the footprint of the gap between the walls 361. Further reduction in overall coil thickness would generally result in diminishing crosstalk performance due to flux leakage around the shield walls 361. Without being bound by theory, this effect is also why having walls 361 extend further away from the winding 355 toward the target 358, including penetrating through a non-conductive bottom plate (if present) generally improves crosstalk performance and reduction in lift-off induced variation in resolution, at the cost of greater EMAT assembly height and decreased signal amplitudes. The examples of FIG. 3A and FIG. 3B assume that an induced current distribution and associated field is constrained by the skin effect to an area near the surface of the walls 361 facing the winding 355, which generally depends on a relationship between material thickness and operating frequency, and associated skin depth of an induced current distribution.

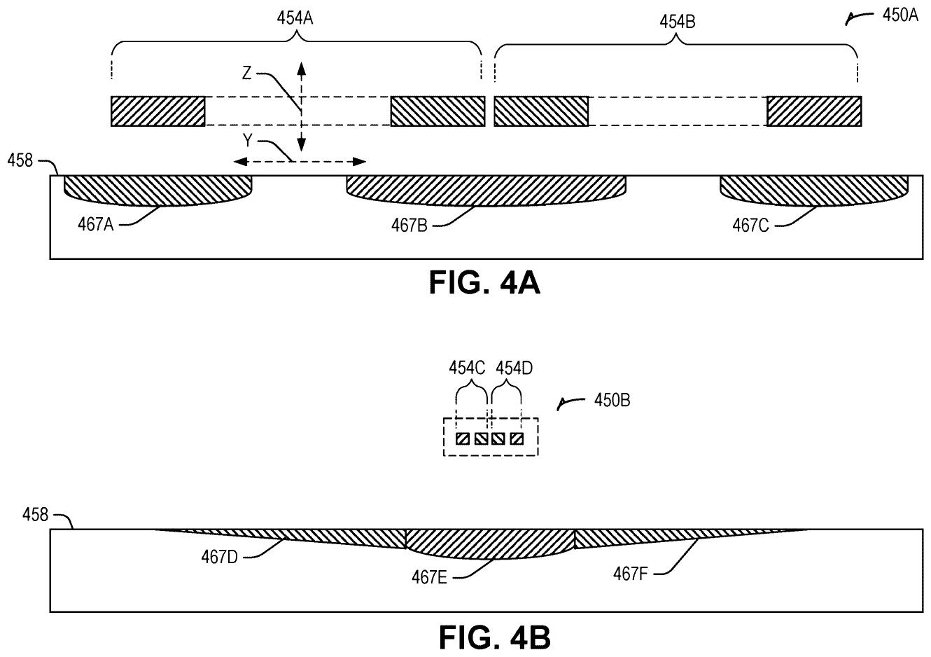

FIG. 4A and FIG. 4B illustrate views of EMAT assemblies 450A and 450B using a coil configuration that differs from other examples in this document, showing that at a scale (e.g., coil-to-coil pitch) generally used for phased-array applications, spatial confinement and resolution are lost when the configuration of FIG. 4A or FIG. 4B is used. In the examples of FIG. 4A and FIG. 4B, transducer coils 454A and 454B (as in FIG. 4A) and transducer coils 454C and 454D (as in FIG. 4B) can correspond to a race-track, meandering, spiral, or butterfly configuration, such as oriented generally parallel to a plane of a surface of a conductive target 558. In such a configuration, windings defining transducer coil 454A, for example, can be wound about an axis Z that is orthogonal to a plane in the direction Y. In the configuration of the EMAT assemblies 450A and 450B, conductors carrying opposing currents are generally kept apart from each other to avoid magnetic field cancelation. As in other examples, hatching indicates current direction, and field polarity, where a current in a conductive winding generally induces a complementary image current in a nearby conductor. Unlike FIG. 3A and FIG. 3A, FIG. 4A and FIG. 4B also show return current distributions (having opposite polarity). As shown in FIG. 4A, the EMAT assembly 450A shows induced fields 467A, 467B, and 467C that closely align with the physical configuration of the transducer coils 454A and 454B. By contrast, when the pitch of the transducer coils is reduced as shown in FIG. 4B, such as corresponding to a phased array application, or if lift-off is significant relative to pitch, the tighter-pitch transducer coils 454C and 454D result in a far less spatially confined (e.g., lower-resolution) field distribution in the target 458 as indicated by the induced fields 467D, 467E, and 467F.

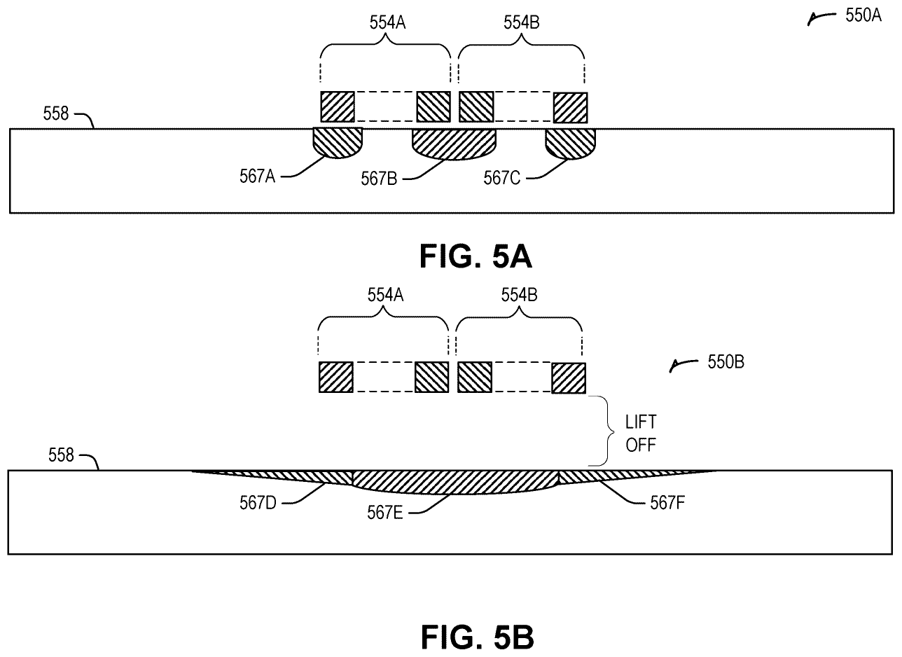

FIG. 5A and FIG. 5B illustrate views of an EMAT assembly similar to FIG. 4A, showing a sensitivity to lift-off, by contrast with other examples in this document. The EMAT assembly 550A and 550B is shown in two different lift-off positions, and similar to FIG. 4A and FIG. 4B, can correspond to a race-track, meandering, spiral, or butterfly configuration, such as where windings of transducer coils 554A and 554B are generally parallel to a plane of a surface of a conductive target 558. When the transducer coils 554A and 554B are in close proximity with the conductive target 558, spatial resolution is maximized as indicated by tight confinement and localization of corresponding induced field regions 567A, 567B, and 567C within the conductive target 558, as shown illustratively in FIG. 5A. In the example of FIG. 5B, where the EMAT assembly 550B is lifted off, moving away from the surface of the target 558, the induced field distributions 567D, 567E, and 567F become more ill-defined and elongated. This illustrates that an effective pitch established by the transducer coils 554A and 554B in FIG. 5B increases as lift-off distance increases, and this is generally an unwanted effect.

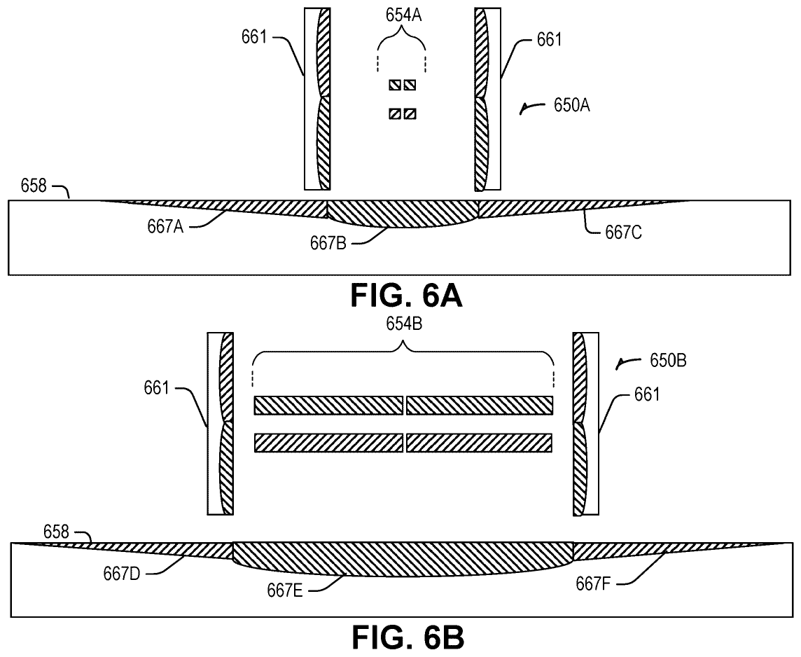

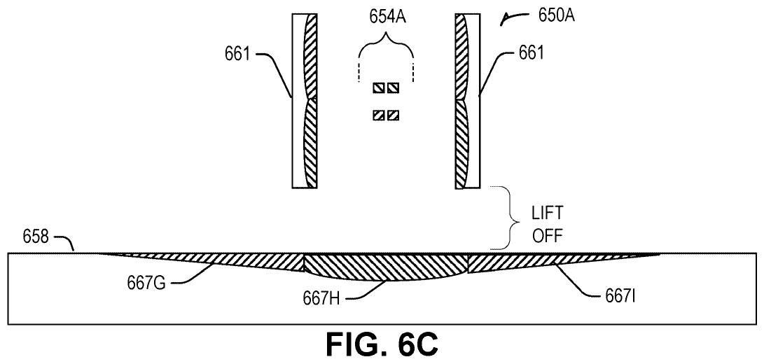

FIG. 6A and FIG. 6B illustrate views of illustrative examples of EMAT assemblies 650A and 650B, similar to the configuration of FIG. 2A and FIG. 2B, illustrating generally that spatial confinement can be maintained for a variety of different lateral widths of coil configuration, and FIG. 6C shows greater consistency in induced field configuration versus lift-off, unlike the examples of FIG. 5A and FIG. 5B, and supporting fine pitch (e.g., on the order of 1 mm coil-to-coil pitch), such as for phased array applications. The narrow coil width of the example of transducer coil 654A shows that a resulting induced field configuration comprising induced fields 667A, 667B, and 667C in the target 658 is largely determined by a separation between conductive shield walls 661, which define a footprint of the central induced field 667B. Similarly, if a specified pitch between conductive shield walls 661 allows for a greater count of turns (because the corresponding transducer coil 654B can be wider as shown in FIG. 6B), the induced field configuration comprising induced fields 667D, 667E, and 667F is still largely determined by a separation between the conductive shield walls. Generally, a larger count of turns translates to a higher flux for a given excitation signal input current. As discussed below, the present inventor has also recognized that it can be desirable if excitation signals and received signals fall within an amplitude and frequency range similar to those used with piezoelectric transducers, to facilitate compatibility with the analog transmitter and analog receiver portions of a test instrument that is otherwise configured for use with piezoelectric transducer probes.

Referring to FIG. 6C, if the EMAT assembly 650A of FIG. 6A is lifted away from a surface of the target 658, the presence of at least two conductive shield walls 661 located laterally of the transducer coil 654A as shown in FIG. 6C (and a conductive shield cap) can result in less variation in the induced field configuration in the target 658, preserving similar spatial localization (e.g., corresponding to resolution) as indicated by the induced field configuration comprising induced fields 667G, 667H, and 667I. In this example, the width of the central induced field 667H would be much larger if the shield walls were not there, due to the higher lift-off magnitude when considered in proportion to the pitch of the transducer coil itself.

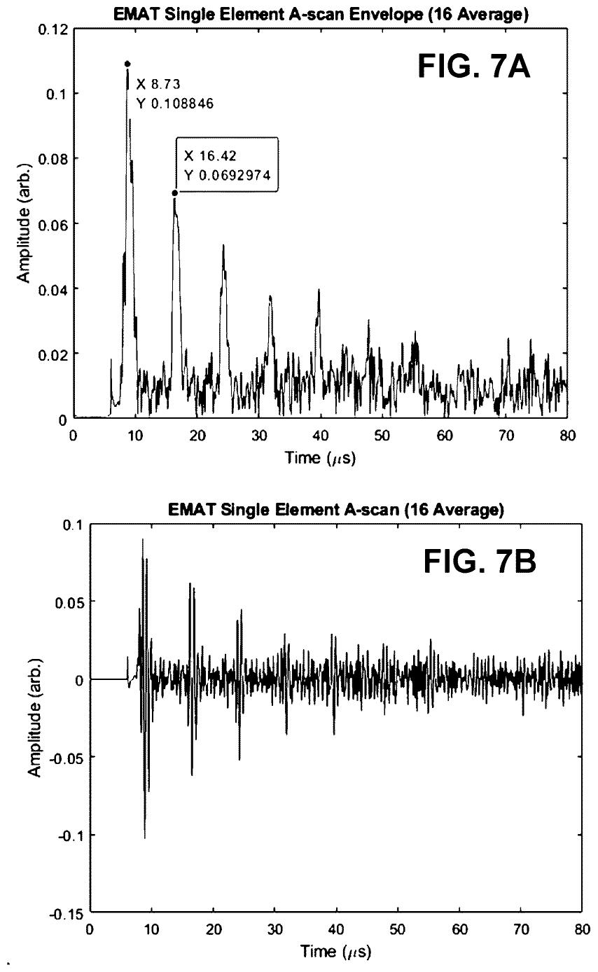

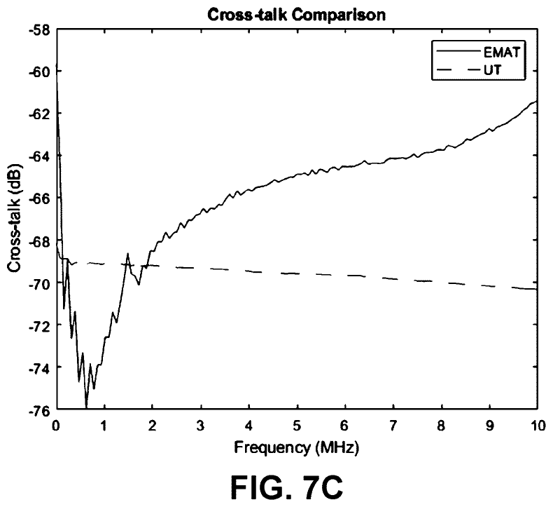

FIG. 7A and FIG. 7B show illustrative examples of an envelope of an A-scan in FIG. 7A, and an A-scan time series in FIG. 7B, both obtained using a single EMAT transducer having a configuration similar to that shown in FIG. 2A and FIG. 2B, with a 1-mm pitch and 10-mm elevation. The plots in FIG. 7A and FIG. 7B were obtained by scanning a steel surface with mild surface corrosion using a test instrument meant for piezoelectric probes (Omniscan X3-64 available from Evident Scientific, Inc., Waltham, MA, USA). The plate thickness was about 12.46 mm, corresponding to an analytically-predicted time-of-flight of 7.691 microseconds for a shear wave (excited by a 2.25 MHz bipolar pulse), and the echo-to-echo time durations in FIG. 7A and FIG. 7B correspond to such a time-of-flight, confirming that a nearly pure shear wave acoustic mode is being generated and detected. A zero-degree angle of the induced ultrasonic beam is also indicated because the spacing between echoes is even throughout the A-scan time series in both FIG. 7A and FIG. 7B. FIG. 7C shows an illustrative example of crosstalk (in dB) between adjacent transducers in a 5-element EMAT phased array having a configuration similar to that shown in FIG. 2A and FIG. 2B (and using a 1-mm pitch and 10-mm elevation), versus a 1-mm pitch and 10-mm elevation piezoelectric phased array transducer assembly (5L32-A32 probe available from Evident Scientific, Inc., Waltham, MA, USA).

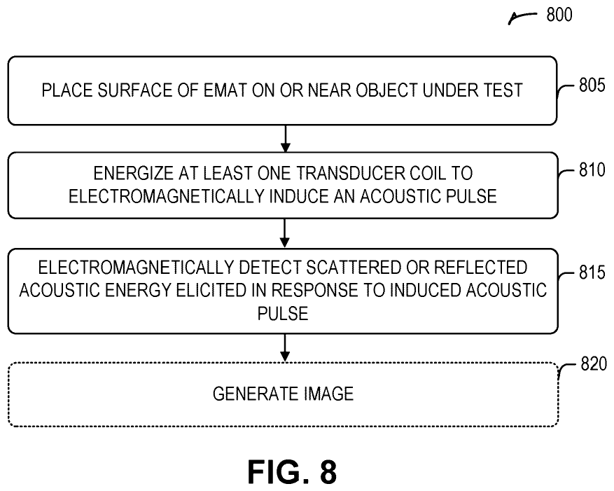

FIG. 8 illustrates generally a technique 800, such as a method, for operating an EMAT such as for generating an acoustic pulse within an object under test, or for detecting echoes elicited by such a pulse (or both). At 805, an EMAT assembly, such as shown and described herein, can be placed on or nearby a conductive object under test. At 810, at least one transducer coil can be energized (e.g., selectively from amongst multiple transducer coils) such as to electromagnetically induce an acoustic pulse in the object under test. For example, as described elsewhere herein, a static field can be established (either using a permanent magnet or an electromagnet), and a time-varying (e.g., pulsed) electromagnetic field can be generated by energizing a transducer coil. A shear wave can be generated within the object under test by a Lorentz force corresponding to the time-varying electromagnetic field produced by the transducer coil in the presence of the static magnetic field. At 815, scattered or reflected acoustic energy can be detected using a reciprocal physical mechanism, such as using the same transducer as was used to deliver the time-varying electromagnetic field, or using another transducer. For example, in a phased array application, a full-matrix capture approach can be used (or other acquisition approach or modes), such as where one transducer coil is used as a transmitter, and other transducer coils are used as receivers. Optionally, at 820, an image or other representation of acoustic energy that was detected at 815 can be generated for presentation to a user. For example, if a full-matrix capture (FMC) acquisition is performed, a Total Focusing Method (TFM) beamforming approach can be applied to generate an image or phase coherence imaging (PCI) can be performed, as illustrative (but non-limiting) examples.

The EMAT probe assembly configurations as described in this document can be fabricated using temperature resistant materials, to be operable at temperatures higher than ambient temperature. As an illustrative example, a phased-array EMAT can be configured for high temperature corrosion scanning, such as supporting continuous operation for a test specimen having an elevated temperature or a depressed temperature relative to an ambient (e.g., typical indoor) temperature. Increasing operational temperature may, up to a point, benefit EMAT probe operation by reducing a conductivity of the inspected medium. For example, steel has 3.30 times more resistance at 350° C. than at 20° C., which increases the skin depth by 82%. Increasing the skin depth reduces the variance caused by surface condition, which may allow support for higher operating frequencies versus lower-temperature applications.

The EMAT probe assembly configurations described in this document can provide continuous operation, without requiring a wedge or acoustic couplant, such as supporting ongoing measurements in industrial operations or harsh environment applications, including those where measurements at elevated temperatures are desired. The EMAT probe assembly configurations described herein, having conductive shield features, can support coil pitches suitable for phased array inspection, such as supporting higher spatial resolution, increased scan speed, or improved flaw detection as compared to mono-element probes. As mentioned above, an EMAT probe assembly configuration can be configured for compatibility with existing piezoelectric-specific test instruments, such as the Omniscan X3-64 as the pulser/receiver (available from Evident Scientific, Inc., Waltham, MA, USA).

### Various Notes

Each of the non-limiting aspects in this document can stand on its own or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. An electromagnetic acoustic transducer (EMAT) assembly for non-destructive test (NDT), the EMAT assembly comprising:
a static magnetic field generator;
a first transducer coil;
a second transducer coil; and
a conductive shield located laterally between the first transducer coil and the second transducer coil, the conductive shield extending away from the first transducer coil and the second transducer coil toward a surface of the EMAT assembly, the surface configured to face an object under test.

2. The EMAT assembly of claim 1, comprising a non-conductive plate defining the surface; and
wherein the conductive shield extends at least partially through the non-conductive plate.

3. The EMAT assembly of claim 2, wherein the conductive shield extends through an entirety of the non-conductive plate defining the surface.

4. The EMAT assembly of claim 3, wherein the conductive shield and the non-conductive plate are configured to wear together over time from contact of the surface with the object under test.

5. The EMAT assembly of claim 4, wherein an exposed portion of the conductive shield and the non-conductive plate are configured for continuous exposure without degradation to an object under test at an above-ambient temperature.

6. The EMAT assembly of claim 1, wherein the conductive shield defines respective walls located on at least two sides laterally of the first transducer coil and the second transducer coil, the respective walls substantially parallel to a plane of windings defining the first transducer coil and the second transducer coil.

7. The EMAT assembly of claim 1, wherein windings defining the first transducer coil and the second transducer coil are wound about an insulator.

8. The EMAT assembly of claim 1, wherein windings defining the first transducer coil and the second transducer coil comprise a single layer.

9. The EMAT assembly of claim 1, wherein windings defining the first transducer coil and the second transducer coil are non-circular and are elongated in a direction parallel to the surface.

10. The EMAT assembly of claim 1, wherein the conductive shield comprises a cap conductively coupled to a wall located laterally between the first transducer coil and the second transducer coil defined by the shield, the cap located opposite a portion of the wall extending toward the surface facing the object under test.

11. The EMAT assembly of claim 1, wherein the conductive shield comprises a non-ferromagnetic material.

12. The EMAT assembly of claim 1, wherein the conductive shield comprises copper.

13. The EMAT assembly of claim 1, wherein a wall defined by the conductive shield located laterally between the first transducer coil and the second transducer coil comprises a thickness that is at least two times a skin depth corresponding to a center operating frequency of the EMAT.

14. The EMAT assembly of claim 1, wherein the first and second transducer coils are amongst a plurality of transducer coils defining channels for use as a phased array.

15. The EMAT assembly of claim 1, wherein the static magnetic field generator comprises a permanent magnet.

16. The EMAT assembly of claim 1, wherein the static magnetic field generator comprises an electromagnet.

17. A method of operating an electromagnetic acoustic transducer (EMAT) assembly for non-destructive test (NDT), the method comprising:
placing a surface of the EMAT assembly of on or near an object under test, the EMAT assembly comprising:
a static magnetic field generator;
a first transducer coil;
a second transducer coil; and
a conductive shield located laterally between the first transducer coil and the second transducer coil, the conductive shield extending away from the first transducer coil and the second transducer coil toward the surface of the EMAT assembly, the surface configured to face an object under test;
selectively energizing at least one of the first transducer coil or the second transducer coil to electromagnetically induce an acoustic pulse in the object under test in a presence of a static magnetic field; and
electromagnetically detecting a scattered or reflected acoustic energy from the object under test elicited in response to the acoustic pulse.

18. The method of claim 17, comprising generating an image using acoustic echo data corresponding to the electromagnetically detected scattered or reflected acoustic energy;
wherein the selective energizing and the electromagnetically detecting comprising operating the EMAT assembly as a phased array.

19. The method of claim 17, wherein an exposed portion of the EMAT assembly on or near the object under test is configured for continuous exposure without degradation when the object under test is at an above-ambient temperature.

20. An electromagnetic acoustic transducer (EMAT) assembly for non-destructive test (NDT), the EMAT comprising:
a means for generating a static magnetic field;
a means for generating a time-varying electromagnetic field using a first transducer coil;
a means for generating a time-varying electromagnetic field using a second transducer coil; and
a means for shielding the first transducer coil from the second transducer coil using a conductive non-ferromagnetic material, the means for shielding the first transducer coil from the second transducer coil configured to reduce a sensitivity of the EMAT assembly to lift-off versus an EMAT assembly without the means for the shielding the first transducer coil from the second transducer coil.
